(19) United States
(12) Patent Application Publication
(10) Pub. No.: US 2020/0099596 A1
(43) Pub. Date: Mar. 26, 2020

(54) Adapting a Millimeter-Wave Wireless Link

(71) Applicant: Apple Inc., Cupertino, CA (US)

(72) Inventors: Ye Sun, San Jose, CA (US); Yakun Sun, San Jose, CA (US); Zhanfeng Jia, Belmont, CA (US)

(21) Appl. No.: 16/139,751

(22) Filed: Sep. 24, 2018

(51) Int. Cl. H04L 12/24; H04L 12/26; H04L 29/06; H04L 1/00

(52) U.S. Cl. CPC H04L 41/5067; H04L 43/0823; H04L 1/0026; H04L 1/0009; H04L 65/80

(57) ABSTRACT

An interface circuit in an electronic device may perform wireless link adaptation. During operation the interface circuit may transmit at least two data streams, where a first data stream of at least the two data streams has a higher quality-of-service (QoS) criterion and a lower modulation coding scheme (MCS), and a second data stream of at least the two data streams has a lower QoS criterion and a higher MCS. Then, the interface circuit may estimate a communication performance metric associated with the second data stream. Next, the interface circuit may selectively transmit an MCS probe associated with the second data stream based at least in part on the communication performance metric and the lower QoS criterion. Moreover, in response to receiving feedback information associated with the recipient electronic device and the MCS probe, the interface circuit may modify the first MCS and/or the second MCS.

### FIELD

The described embodiments relate, generally, to wireless communications among electronic devices, and techniques for adapting a wireless link by, e.g., using different modulation coding schemes for data streams having different priorities (or associated qualities of service).

### BACKGROUND

Many electronic devices communicate with each other using wireless local area networks (WLANs), such as those based on a communication protocol that is compatible with an IEEE 802.11 standard (which is sometimes referred to as ‘Wi-Fi’).

Recently, wireless communication in short-wavelength bands of frequencies (which is sometimes referred to as ‘millimeter-wave communication’) has been proposed. In principle, millimeter-wave communication offers the advantages of ultrawide bandwidth and high spatial isolation (and, thus, reduced interference and collisions).

However, because of dynamic channel or link characteristics, in practice it can be difficult to provide reliable, low-latency wireless links using millimeter-wave communication. These problems can degrade the performance of applications (such as video streaming) and, thus, the user experience.

### SUMMARY

A first group of embodiments relates to an electronic device that performs wireless link adaptation. This electronic device may include a node that can be communicatively coupled to an antenna, and an interface circuit communicatively coupled to the node and that communicates with a recipient electronic device. During operation, the interface circuit transmits, via the node, at least two data streams, where a first data stream of at least the two data streams has a higher quality-of-service (QoS) criterion and a lower modulation coding scheme (MCS), and a second data stream of at least the two data streams has a lower QoS criterion and a higher MCS. Then, the interface circuit estimates a communication performance metric associated with the second data stream. Next, the interface circuit selectively transmits, via the node, an MCS probe associated with the second data stream based at least in part on the communication performance metric and the lower QoS criterion.

Moreover, the interface circuit may receive, at the node, feedback information associated with the recipient electronic device and the MCS probe. The interface circuit may modify at least one of the first MCS or the second MCS based at least in part on the feedback information.

Note that a given QoS criterion may include a packet-error-rate (PER) threshold. Moreover, the communication performance metric may include at least one of a PER, a received signal strength, or a signal-to-noise ratio (SNR).

Furthermore, the MCS probe may use a probe MCS that is different from the second MCS.

Additionally, the first data stream and the second data stream may be associated with a 60 GHz frequency band.

In some embodiments, during a beamforming condition, the interface circuit may reset at least one of the first MCS or the second MCS.

Other embodiments provide an interface circuit in the electronic device.

Other embodiments provide a computer-readable storage medium for use with the interface circuit in the electronic device. When program instructions stored in the computer-readable storage medium are executed by the interface circuit, the program instructions may cause the electronic device to perform at least some of the aforementioned operations of the electronic device.

Other embodiments provide a method for performing wireless link adaptation. The method includes at least some of the aforementioned operations performed by the interface circuit in the electronic device.

Other embodiments provide the recipient electronic device.

A second group of embodiments relates to an electronic device that performs wireless link adaptation. This electronic device may include a node that can be communicatively coupled to an antenna, and an interface circuit communicatively coupled to the node and that communicates with a recipient electronic device. During operation, the interface circuit estimates a communication performance metric associated with a wireless link. Based at least in part on the communication performance metric and a QoS criterion, the interface circuit selectively generates an aggregate physical layer convergence protocol (PLCP) protocol data unit (APPDU) and selectively transmits, via the node, the APPDU intended for the recipient electronic device. Note that generating the APPDU may involve appending a PPDU associated with a data stream using a probe MCS to one or more PPDUs associated with the same or a different data stream using an MCS that is different than the probe MCS.

In some embodiments, the APPDU is generated when the communication performance metric is less than the QoS criterion. Alternatively, when the communication performance metric is greater than the QoS criterion, the interface circuit may selectively generate a second APPDU and may selectively transmit, via the node, the second APPDU intended for the recipient electronic device. Note that generating the second APPDU may involve using the probe MCS with one or more second PPDUs associated with the data stream.

Moreover, the interface circuit may receive, at the node, feedback information associated with the recipient electronic device and the APPDU or the second APPDU. The interface circuit may modify the MCS based at least in part on the feedback information.

Note that the QoS criterion may include a packet-error-rate (PER) threshold. Moreover, the communication performance metric may include at least one of a PER, a received signal strength, or an SNR.

Furthermore, the APPDU or the second APPDU may be associated with a 60 GHz frequency band.

Additionally, during a beamforming condition, the interface circuit may reset the MCS.

Other embodiments provide an interface circuit in the electronic device for performing wireless link adaptation.

Other embodiments provide a computer-readable storage medium for use with the interface circuit in the electronic device. When program instructions stored in the computer-readable storage medium are executed by the interface circuit, the program instructions may cause the electronic device to perform at least some of the aforementioned operations of the electronic device, including for performing wireless link adaptation.

Other embodiments provide a method for performing wireless link adaptation. The method includes at least some of the aforementioned operations performed by the interface circuit in the electronic device.

Other embodiments provide the recipient electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 is a block diagram illustrating an example of electronic devices communicating wirelessly.

FIG. 2 is a drawing illustrating an example of multiple data streams communicated between electronic devices in FIG. 1.

FIG. 3 is a flow diagram illustrating an example method for performing wireless link adaptation using one of the electronic devices in FIG. 1.

FIG. 4 is a flow diagram illustrating an example of communication between electronic devices, such as the electronic devices of FIG. 1.

FIG. 5 is a flow diagram illustrating an example method for performing wireless link adaptation using one of the electronic devices in FIG. 1.

FIG. 6 is a flow diagram illustrating an example of communication between electronic devices, such as the electronic devices of FIG. 1.

FIG. 7 is a flow diagram illustrating an example method for performing wireless link adaptation using one of the electronic devices in FIG. 1.

FIG. 8 is a flow diagram illustrating an example method for performing wireless link adaptation using one of the electronic devices in FIG. 1.

FIG. 9 is a flow diagram illustrating an example method for performing wireless link adaptation using one of the electronic devices in FIG. 1.

FIG. 10 is a drawing illustrating an example beamforming condition during communication using one of the electronic devices in FIG. 1.

FIG. 11 is a timing diagram illustrating an example of communication between electronic devices, such as the electronic devices of FIG. 1.

FIG. 12 is a block diagram illustrating an example of one of the electronic devices of FIG. 1.

Note that like reference numerals refer to corresponding parts throughout the drawings. Moreover, multiple instances of the same part are designated by a common prefix separated from an instance number by a dash.

### DETAILED DESCRIPTION

An interface circuit in an electronic device (such as an access point) may perform wireless link adaptation. During operation the interface circuit may transmit at least two data streams, where a first data stream of at least the two data streams has a higher quality-of-service (QoS) criterion and a lower modulation coding scheme (MCS), and a second data stream of at least the two data streams has a lower QoS criterion and a higher MCS. More data streams, e.g., three, four, etc. can be transmitted in other embodiments. Then, the interface circuit may estimate a communication performance metric associated with the second data stream. Next, the interface circuit may selectively transmit an MCS probe associated with the second data stream based at least in part on the communication performance metric and the lower QoS criterion. Moreover, in response to receiving feedback information associated with the recipient electronic device and the MCS probe, the interface circuit may modify the first MCS and/or the second MCS. For example, the first MCS and/or the second MCS may be modified based at least in part on the feedback information.

By selectively probing the wireless link using the second data stream (which has the lower QoS criterion), this communication technique may enable the electronic device to perform the wireless link adaptation with reduced or negligible impact on content associated with the first and second data streams, such as video streaming. Moreover, by enabling the wireless link adaptation, this communication technique may allow the electronic device to adapt to a dynamic wireless environment. This capability may allow the use of millimeter-wave communication, such as a 60 GHz frequency band, for various applications, including streaming media. Consequently, the communication technique may provide ultrawide bandwidth and high spatial isolation (and, thus, reduced interference and collisions) with reliable, low-latency wireless links. Thus, the communication technique may improve the user experience when using the electronic device and/or the recipient electronic device, and therefore may increase customer satisfaction and retention.

Note that the communication technique may be used during wireless communication between electronic devices in accordance with a communication protocol, such as a communication protocol that is compatible with an IEEE 802.11 standard (which is sometimes referred to as Wi-Fi). In some embodiments, the communication technique is used with IEEE 802.11ad and/or IEEE 802.11ay, which are used as illustrative examples in the discussion that follows. However, this communication technique may also be used with a wide variety of other communication protocols, and in electronic devices (such as portable electronic devices or mobile devices) that can incorporate multiple different radio access technologies (RATs) to provide connections through different wireless networks that offer different services and/or capabilities.

An electronic device can include hardware and software to support a wireless personal area network (WPAN) according to a WPAN communication protocol, such as those standardized by the Bluetooth Special Interest Group (in Kirkland, Wash.) and/or those developed by Apple (in Cupertino, Calif.) that are referred to as an Apple Wireless Direct Link (AWDL). Moreover, the electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; IEEE 802.11ax, IEEE 802.11ad, IEEE 802.11ay or other present or future developed IEEE 802.11 technologies.

In some embodiments, the electronic device can act as a communications hub that provides access to a WLAN and/or to a WWAN and, thus, to a wide variety of services that can be supported by various applications executing on the electronic device. Thus, the electronic device may include an ‘access point’ that communicates wirelessly with other electronic devices (such as using Wi-Fi), and that provides access to another network (such as the Internet) via IEEE 802.3 (which is sometimes referred to as ‘Ethernet’). However, in other embodiments the electronic device may not be an access point. As an illustrative example, in the discussion that follows the electronic device is or includes an access point.

Additionally, it should be understood that the electronic devices described herein may be configured as multi-mode wireless communication devices that are also capable of communicating via different 3G and/or second generation (2G) RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) may be used herein to describe one or more consumer electronic devices that may be capable of performing procedures associated with various embodiments of the disclosure.

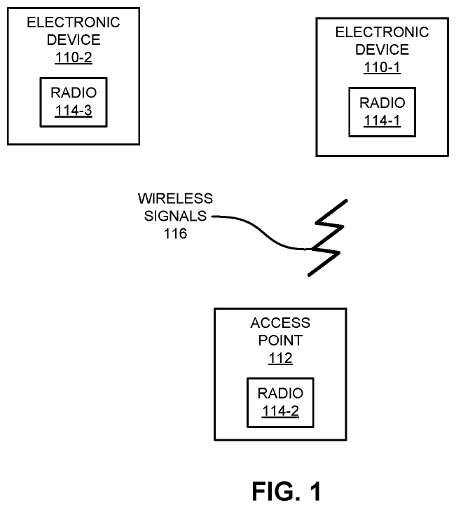

FIG. 1 presents a block diagram illustrating an example of electronic devices communicating wirelessly. Notably, one or more electronic devices 110 (such as a smartphone, a laptop computer, a notebook computer, a tablet, an auxiliary or virtual reality headset or display, wearable device, or another such electronic device) and access point 112 may communicate wirelessly in a WLAN using an IEEE 802.11 communication protocol. Thus, electronic devices 110 may be associated with access point 112. For example, electronic devices 110 and access point 112 may wirelessly communicate while: detecting one another by scanning wireless channels, transmitting and receiving beacons or beacon frames on wireless channels, establishing connections (for example, by transmitting connect requests), and/or transmitting and receiving packets or frames (which may include the request and/or additional information, such as data, as payloads). Note that access point 112 may provide access to a network, such as the Internet, via an Ethernet protocol, and may be a physical access point or a virtual or ‘software’ access point that is implemented on a computer or an electronic device. In the discussion that follows, electronic devices 110 are sometimes referred to as ‘recipient electronic devices.’

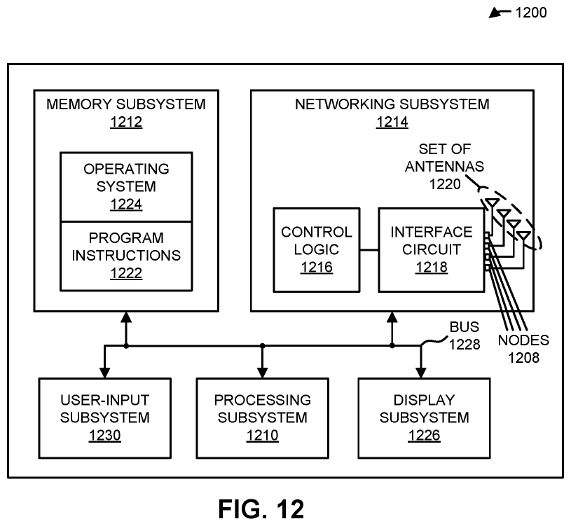

As described further below with reference to FIG. 12, electronic devices 110 and access point 112 may include subsystems, such as a networking subsystem, a memory subsystem, and a processor subsystem. In addition, electronic devices 110 and access point 112 may include radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

As can be seen in FIG. 1, wireless signals 116 (represented by a jagged line) are communicated by radios 114-1 and 114-2 in electronic device 110-1 and access point 112, respectively. For example, electronic device 110-1 and access point 112 may exchange packets using a Wi-Fi communication protocol in a WLAN. Notably, radio 114-1 may receive wireless signals 116 that are transmitted by radio 114-2. Alternatively, radio 114-1 may transmit wireless signals 116 that are received by radio 114-2.

In some embodiments, wireless signals 116 are communicated using wavelengths in the microwave portion of the electromagnetic spectrum. For example, wireless signals 116 may be communicated using a 60 GHz frequency band. Other suitable frequency bands also may be used. Moreover, electronic device 110-1 and access point 112 may transmit and receive wireless signals (such as wireless signals 116) using directional antenna patterns (such as a transmit antenna pattern and a receive antenna pattern). As noted previously, such millimeter-wave communication can provide ultrawide bandwidth and high spatial isolation.

However, millimeter-wave communication can be sensitive. For example, characteristics of the wireless link between electronic device 110-1 and access point 112 may vary dynamically. These variations can degrade the communication performance, such as a reduced throughput or an increased latency.

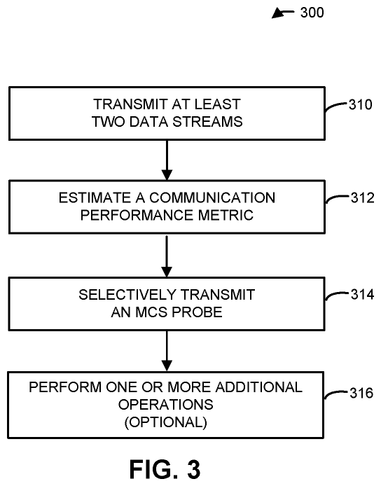

In order to address this challenge, access point 112 may use the communication technique to perform wireless link adaptation. Notably, as described further below with reference to FIGS. 3, 4 and 8, access point 112 may transmit to electronic device 110-1 at least two data streams having different QoS criteria (such as acceptable PER thresholds) or different priorities. Moreover, these data streams may have different MCS values. For example, a first data stream of at least the two data streams may have a higher QoS criterion and a lower MCS, and a second data stream of at least the two data streams may have a lower QoS criterion and a higher MCS. Furthermore, access point 112 may estimate or determine a communication performance metric (such as a PER, a received signal strength, e.g., an RRSI, an SNR, etc.) associated with the second data stream, e.g., with the communication with electronic device 110-1.

When one or more probe criteria are met (such as an elapsed time since a previous probing of the wireless link between access point 112 and electronic device 110-1 and/or based at least in part on one or more communication performance metrics of the wireless link), access point 112 may probe the wireless link using the second data stream, which has the lower QoS. Notably, access point 112 may selectively transmit, to electronic device 110-1, an MCS probe associated with the second data stream. This MCS probe may have a different MCS than the second MCS. Note that the elapsed time or time window may depend on a coherence or stability of the wireless link or channel and/or the traffic. In some embodiments, the elapsed time or time window may be tens or hundreds of milliseconds. Moreover, in some embodiments the probing occurs during a blanking interval.

Based at least in part on feedback information associated with electronic device 110-1 and the MCS probe (such as feedback information about the MCS probe that is received from electronic device 110-1), access point 112 may modify at least one of the first MCS or the second MCS. Thus, access point 112 may selectively probe the MCS of the wireless link using a data stream having a lower QoS and, based at least in part on the results of this probe, may perform wireless link adaptation.

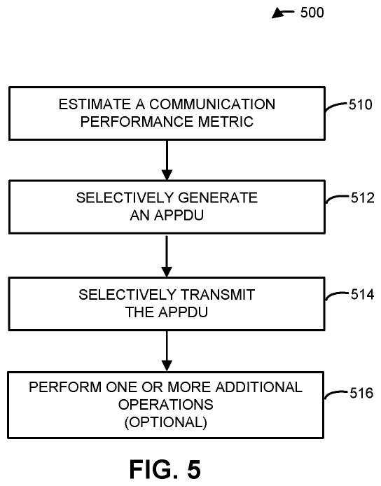

Alternatively, as described further below, e.g., with reference to FIGS. 5-6 and 9, when one or more probe criteria are met (such as an elapsed time and/or when a communication performance metric is less than a QoS criterion), access point 112 may probe the wireless link using a modified APPDU. Notably, access point 112 may selectively transmit, to electronic device 110-1, the modified APPDU that includes one or more PPDUs associated with a data stream that uses an MCS, and that includes or has an appended PPDU associated with the same or a different data stream that uses a probe MCS. In some embodiments, when the communication performance metric exceeds the QoS criterion, the modified APPDU may include one or more PPDUs associated with a data stream and that use the probe MCS.

Based at least in part on feedback information associated with electronic device 110-1 and the modified APPDU (such as feedback information about the modified APPDU that is received from electronic device 110-1), access point 112 may modify the MCS. Thus, access point 112 may selectively probe the MCS of the wireless link using the modified APPDU and, based at least in part on the results of this probe, may perform wireless link adaptation.

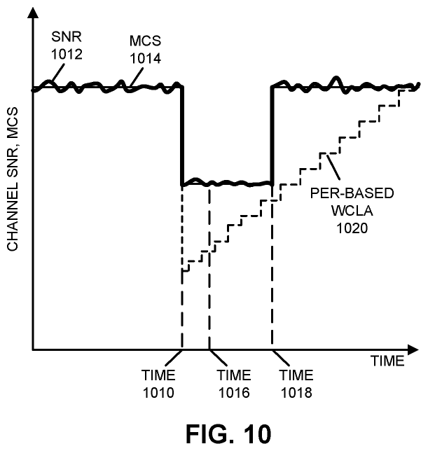

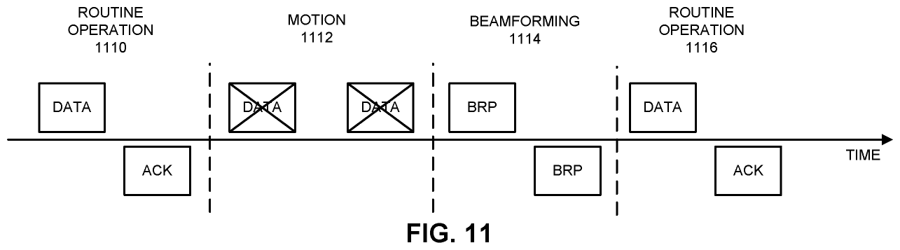

Because the millimeter-wave communication may use directional antenna patterns, depending on the one or more communication performance metrics associated with the wireless link, electronic device 110-1 and/or access point 112 may selectively perform beamforming to revise one or more directional antenna patterns. During such a beamforming condition, access point 112 may need to rapidly modify the MCS. Notably, as described further below with reference to FIGS. 10 and 11, during a beamforming condition, access point 112 may reset the first MCS and/or the second MCS, and more generally an MCS associated with a data stream.

In these ways, the communication technique may allow electronic devices 110 and access point 112 to communicate reliably and efficiently (such as with low latency and ultrawide bandwidth), with high spatial isolation (and, thus, reduced interference and collisions). For example, the communication technique may allow electronic devices 110 and access point 112 to communicate using a 60 GHz frequency band. These capabilities may improve the user experience when using electronic devices 110 and/or access point 112.

Note that access point 112 and at least some of electronic devices 110 may be compatible with an IEEE 802.11 standard that includes trigger-based channel access (such as IEEE 802.11ax). However, access point 112 and at least this subset of electronic devices 110 may also communicate with one or more legacy electronic devices that are not compatible with the IEEE 802.11 standard (i.e., that do not use multi-user trigger-based channel access). In some embodiments, at least a subset of electronic devices 110 use multi-user transmission (such as orthogonal frequency division multiple access or OFDMA). For example, radio 114-2 may provide a trigger frame for the subset of recipient electronic devices. Moreover, after radio 114-1 receives a trigger frame, radio 114-1 may provide a group acknowledgment to radio 114-2. For example, radio 114-1 may provide the acknowledgment during an assigned time slot and/or in an assigned channel in the group acknowledgment. However, in some embodiments the one or more recipient electronic devices may individually provide acknowledgments to radio 114-2. Thus, after radio 114-1 receives the trigger frame, radio 114-1 (and, more generally, the main radios in the one or more recipient electronic devices) may provide an acknowledgment to radio 114-2.

In the described embodiments, processing a packet or frame in one of electronic devices 110 and access point 112 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

In general, the communication via the WLAN in the communication technique may be characterized by a variety of communication-performance metrics. For example, the communication-performance metric may include any/all of: an RSSI, a data rate, a data rate for successful communication (which is sometimes referred to as a ‘throughput’), a latency, an error rate (such as a retry or resend rate, packet error rate, etc.), a mean-square error of equalized signals relative to an equalization target, inter-symbol interference, multipath interference, an SNR, a width of an eye pattern, a ratio of a number of bytes successfully communicated during a time interval (such as a time interval between, e.g., 1 and 10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices may be present. For example, some embodiments may include more or fewer electronic devices. As another example, in other embodiments, different electronic devices can be transmitting and/or receiving packets or frames.

High-definition, low latency video streaming over wireless links can provide an improved user experience. The ultrawide bandwidth and high spatial isolation provided by millimeter-wave communication may be useful in these applications. However, it can be challenging to support link adaptation for millimeter-wave communication.

For example, video quality may be sensitive to packet lost. At the same time, there are often limited retry opportunities given the latency requirements associated with video streaming. Consequently, wireless link adaptation may need to provide a reliable and not-too-conservative estimate of the transmission rate for video streaming.

Moreover, video may be encoded and transmitted in multiple data streams, each of which may have different priorities and requirements (e.g., PER thresholds, etc.). For example, a base layer or data stream may need to have higher reliability (and, thus, may have a higher QoS criterion). Wireless link adaptation may need to select the suitable MCS for each data stream in order to meet the individual requirements of these data streams.

Furthermore, because of the use of directional beams that are associated with directional antenna patterns, millimeter-wave communication may be sensitive to motion (such as blockage and rotation), which are sometimes referred to as ‘scenario changes’. It is often difficult to distinguish these scenario changes from channel fading. Consequently, wireless link adaptation may need to react differently to channel fading and scenario changes.

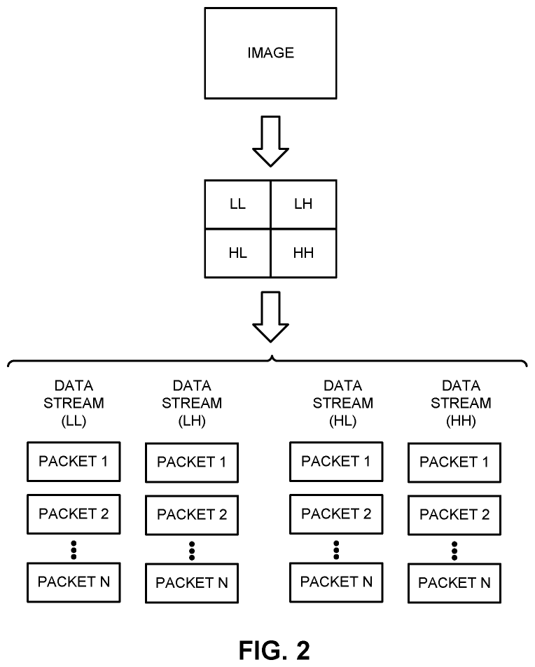

FIG. 2 presents a flow diagram illustrating an example of multiple data streams communicated between access point 112 and recipient electronic device 110-1, e.g., during video streaming. Notably, a transformation of video (such as a wavelet or discrete cosine transform), may result in different data streams. These data streams may be transmitted using different MCS values. For example, as shown in FIG. 2, there may be four different data streams associated with the LL, LH, HL and HH bands. Note that the LL band may be a base layer with coarse transformation coefficients, while the LH, HL and HH bands may include fine transformation coefficients. More generally, the different data streams may carry bits or information of different significance or importance.

In addition to different MCS values, the different data streams may have different QoS requirements or criteria. For example, the data stream associated with the LL band may be needed in order to obtain a rough image. Consequently, the associated QoS criterion may be that the PER is less than 0.1% (to ensure that there are very few errors). However, the data stream associated with the HH band may be less important. Consequently, the associated QoS criterion may be that the PER is equal to or greater than 10.0%

Note that one the data streams associated with the video streaming arrive in a MAC layer in a recipient electronic device, they may be placed into different QoS queues with different traffic identifiers.

Because of varying wireless conditions, in general, during millimeter-wave communication, the MCS values of the different data streams may need to be dynamically adapted in order to provide reliable wireless communication. For example, in bad communication conditions, the base layer may use an MCS of 0, 1 or 2 (with a data rate of up to 7 Gbps) and the other layers may, respectively, use MCS values of 3, 4 and 5. Alternatively, in good communication conditions, the base layer may use an MCS of 10, the second layer may use an MCS of 11, the third layer may use an MCS of 12, etc.

In the communication technique, suitable MCS values for the different data streams may be dynamically determined by selectively probing the MCS of the wireless link using a data stream having a lower or the minimum QoS criterion. Then, wireless link adaptation (such as modifying the MCS values of one or more data streams) may be performed based at least in part on feedback information received in response to the selective probe.

FIG. 3 presents a flow diagram illustrating an example method 300 for performing wireless link adaptation. This method may be performed by an electronic device, such as an interface circuit in access point 112 in FIG. 1. During operation, the electronic device may transmit at least two data streams (operation 310), where a first data stream of at least the two data streams has a higher QoS criterion and a lower MCS, and a second data stream of at least the two data streams has a lower QoS criterion and a higher MCS. Note that a given QoS criterion may include a PER threshold.

Then, the electronic device may estimate a communication performance metric (operation 312) associated with at least the second data stream. For example, the communication performance metric may include: a PER, a received signal strength, and/or an SNR.

Next, the electronic device may selectively transmit an MCS probe (operation 314) associated with the second data stream based at least in part on the communication performance metric and the lower QoS criterion. The MCS probe may use a probe MCS that is different from the second MCS.

In some embodiments, the electronic device optionally performs one or more additional operations (operation 316). For example, the electronic device may receive feedback information associated with the recipient electronic device and the MCS probe. Then, the electronic device may modify at least one of the first MCS or the second MCS based at least in part on the feedback information.

Furthermore, during a beamforming condition, the electronic device may reset at least one of the first MCS or the second MCS. Note that a beamforming condition may occur when there is a change in an SNR or an RSSI that is greater than a threshold, such as, e.g., 10 dB, or when there is packet loss (such as when no acknowledgment(s) are received).

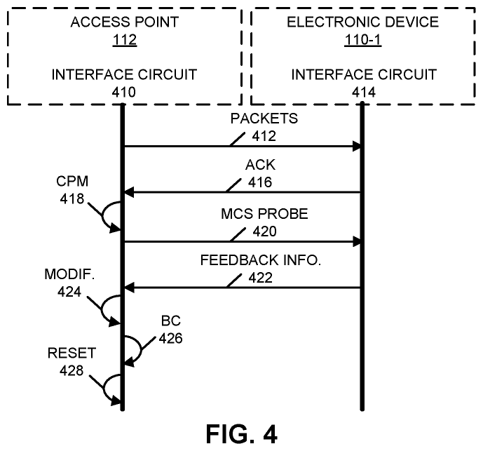

The communication technique is further illustrated in FIG. 4, which presents a flow diagram illustrating an example of communication between electronic device 110-1 and access point 112. Interface circuit 410 in access point 112 may transmit packets 412 or frames associated with at least two data streams. These data streams may have different QoS criteria and different MCS values.

After receiving packets 412, interface circuit 414 in electronic device 110-1 may provide acknowledgments (ACK) 416. Based at least in part on these acknowledgments, interface circuit 410 may determine or estimate a communication performance metric (CPM) 418 associated with the communication between access point 112 and electronic device 110-1. For example, the communication performance metric may be associated with one of the data streams, such as a data stream having a lower QoS.

Then, interface circuit 410 may selectively transmit an MCS probe 420 associated with the data stream having a lower QoS. This MCS probe may use a probe MCS that is different from the MCS currently used with the data stream.

After receiving packets 420, interface circuit 414 in electronic device 110-1 may provide feedback information 422, such as acknowledgments. Based at least in part on the feedback information 422, interface circuit 410 may modify 424 at least an MCS associated with one of the data streams.

In some embodiments, when a beamforming condition (BC) 426 occurs, interface circuit 410 may reset 428 (and, more generally, may modify) at least an MCS associated with one of the data streams.

FIG. 5 presents a flow diagram illustrating an example method 500 for performing wireless link adaptation. This method may be performed by an electronic device, such as an interface circuit in access point 112 in FIG. 1. During operation, the electronic device may determine or estimate a communication performance metric (operation 510) associated with a wireless link. For example, the communication performance metric may include: a PER, a received signal strength, and/or an SNR.

Based at least in part on the communication performance metric and a QoS criterion, the electronic device may selectively generate an APPDU (operation 512) and may selectively transmit the APPDU (operation 514) intended for the recipient electronic device. For example, the APPDU may be generated when the communication performance metric is less than the QoS criterion, such as when a PER is less than a PER threshold. Note that, in these embodiments, generating the APPDU may involve appending a PPDU associated with a data stream using a probe MCS to one or more PPDUs associated with the same or a different data stream using an MCS that is different than the probe MCS. Alternatively, when the communication performance metric is greater than the QoS criterion (such as when a PER is greater than a PER threshold), generating the APPDU may involve using the probe MCS with one or more PPDUs associated with the data stream.

In some embodiments, the electronic device optionally performs one or more additional operations (operation 516). For example, the electronic device may receive feedback information associated with the recipient electronic device and the APPDU. Then, the electronic device may modify the MCS based at least in part on the feedback information.

Furthermore, during a beamforming condition, the electronic device may reset the MCS.

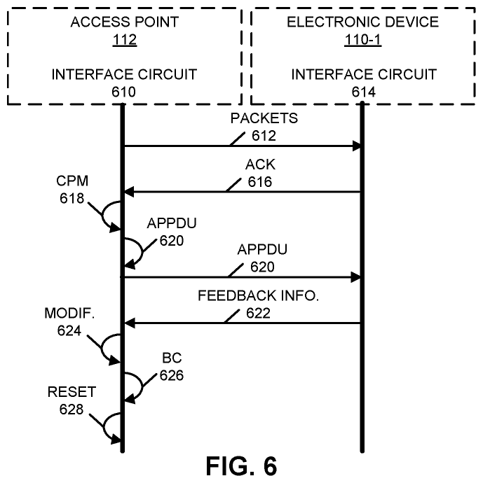

The communication technique is further illustrated in FIG. 6, which presents a flow diagram illustrating an example of communication between electronic device 110-1 and access point 112. Interface circuit 610 in access point 112 may transmit packets 612 or frames associated with at least a data stream.

After receiving packets 612, interface circuit 614 in electronic device 110-1 may provide acknowledgments 616. Based at least in part on these acknowledgments, interface circuit 610 may determine or estimate a communication performance metric (CPM) 618 associated with the communication between access point 112 and electronic device 110-1.

Then, based at least in part on the communication performance metric 618 and a QoS criterion associated with the data stream, interface circuit 610 may selectively generate an APPDU 620 and may selectively transmit APPDU 620 to electronic device 110-1. For example, APPDU 620 may include a PPDU associated with a data stream using a probe MCS that is appended to one or more PPDUs associated with the same or a different data stream using an MCS that is different than the probe MCS. Alternatively, APPDU 620 may include one or more PPDUs associated with the data stream using the probe MCS.

After receiving APPDU 620, interface circuit 614 in electronic device 110-1 may provide feedback information 622, such as an acknowledgment. Based at least in part on the feedback information 622, interface circuit 610 may modify 624 at least the MCS associated with the data stream.

In some embodiments, when a beamforming condition 626 occurs, interface circuit 610 may reset 628 (and, more generally, may modify) at least the MCS associated with the data stream.

While communication between the components in FIGS. 4 and 6 are illustrated with unilateral or bilateral communication (e.g., lines having a single arrow or dual arrows), in general a given communication operation may be unilateral or bilateral.

In many existing link-adaptation techniques, a higher MCS is ‘probed’ when certain conditions are met. For example, the probe may occur when the PER associated with the current MCS is lower than a PER threshold and/or when a timer expires. The intent of the probe may be to test or assess if the channel or wireless link is good enough to support a higher MCS and, thus, can achieve a higher throughput.

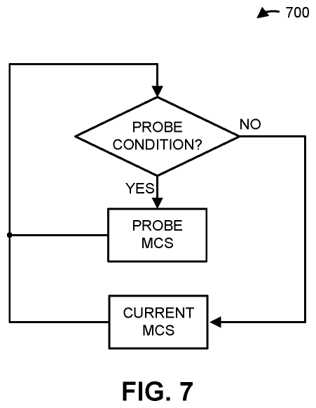

FIG. 7 presents a flow diagram illustrating a method 700 for performing wireless link adaptation. As shown in FIG. 7, typically, whenever the probe condition is met, the next frame may be transmitted using the probe MCS, regardless of which data stream the frame is associated with and the QoS criterion associated with the data stream.

In the communication technique, wireless link adaptation may exploit the different tolerances of different data streams to packet errors to probe the channel. Notably, in the communication technique, higher layers may be used to perform low-priority probing of the channel. For example, when multi-data-stream video traffic arrives, probing can use a lower-priority data stream (from the corresponding QoS queue). The lower-priority data stream may be more tolerant to a higher PER (and, thus, to a higher packet loss). Consequently, probing using a lower-priority data stream may result in less or reduced impact on video quality. Thus, in some embodiments, a lower-priority data stream may have an MCS of 6 with a PER of 6%. During the probing, the MCS of packets or frames associated with this lower-priority data stream may be increased. If the wireless link or channel is able to support the higher MCS, the MCS of a data stream associated with a base layer may be increased.

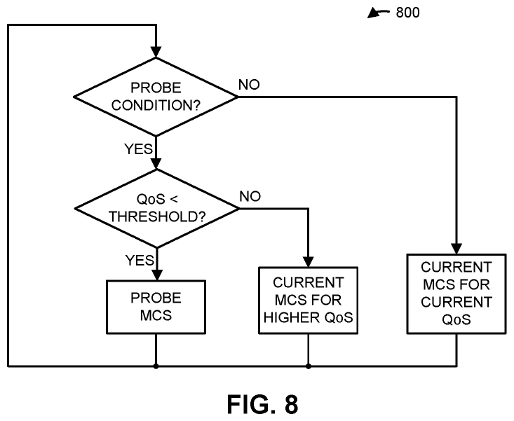

FIG. 8 presents a flow diagram illustrating an example of a method 800 for performing wireless link adaptation using access point 112. In method 800, when a probe condition is met, probing may occur when transmitting a lower-priority data stream (such as from a lower QoS queue) or when a frame from the lower-priority data stream is schedule. During the transmission, a probe MCS may be used (instead of the current MCS associated with the higher-priority data stream). Otherwise, if the probe condition is not met, the current MCS for the current-priority data stream may be used.

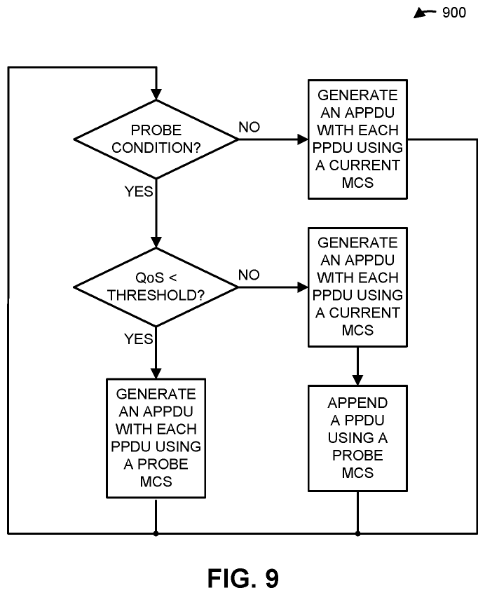

FIG. 9 presents a flow diagram illustrating an example of a method 900 for performing wireless link adaptation using access point 112. In method 900, probing may occur using an APPDU (when an APPDU is supported). Alternatively, when an APPDU is supported and a probe condition is met, the probe MCS may be used to transmit packets or frames from a lower QoS queue (such as when a PER is less than a PER threshold), or to append a PPDU of packets or frames from the lower QoS queue using the probe MCS to the PPDUs from a higher QoS queue using a high-QoS MCS (such as when the PER is greater than a PER threshold).

In some embodiments of methods 300, 500, 700, 800 and/or 900, there may be additional or fewer operations. Moreover, the order of the operations may be changed, and/or two or more operations may be combined into a single operation or performed at least partially in parallel.

In some embodiments, at least some of the operations in methods 300, 500, 700, 800 and/or 900 are performed by an interface circuit in the electronic device. For example, at least some of the operations may be performed by firmware executed by an interface circuit, such as firmware associated with a MAC layer, as well as one or more circuits in a physical layer in the interface circuit.

Based at least in part on the feedback information associated with the probe(s), the electronic device may increase the MCS for one or more data streams. In general, the electronic device may be conservative when increasing the MCS and may be more aggressive when decreasing the MCS. For example, the MCS may be increased in steps of one or two if the wireless link or channel can support it.

In some embodiments, the electronic device may transmit one or more APPDUs to probe the wireless link in order to accumulate sufficient statistics to determine that the PER is stable. Alternatively or additionally, an SNR may be used to guide the wireless link adaptation (which is sometimes referred to as ‘channel-aware probing’). Furthermore, in some embodiments, the wireless link adaptation may, at least in part, be application-aware and/or content-aware. In these ways, the wireless link adaptation may be based at least in part on traffic and/or application requirements.

The wireless link adaption may include techniques to address issues that occur during beamforming. In the communication technique, channel conditions are typically tracked based at least in part on acknowledgments or block acknowledgments. In some embodiments, a filtered channel condition may be tracked, such as a moving average or low-pass-filtered PER associated with an MCS. As discussed previously, the MCS may be gradually increased or decreased based at least in part on the tracked channel condition and a performance target. For example,

$${N}_{Total \_ Tx \_ MPDU} ( MCS , t ) = ( 1 - α ) \cdot {N}_{Total \_ Tx \_ MPDU} ( MCS , t - 1 ) + α \cdot {N}_{Current \_ T x \_ MPDU} ( MCS , t ) , \\ {N}_{Total \_ Succ \_ MPDU} ( MCS , t ) = ( 1 - α ) \cdot {N}_{Tota l \_ Succ \_ MPDU} ( MCS , t - 1 ) + α \cdot {N}_{Current \_ Succ \_ MPDU} ( MCS , t ) , \\ PER ( MCS , t ) = \frac{{N}_{Tota l \_ SUCC \_ MPDU} ( MCS , t )}{{N}_{Total \_ Tx \_ MPDU} ( MCS , t )} , and$$

$$MCS ( t + 1 ) = {argmax}_{MCS} PER ( MCS , t ) \leq {PER}_{Target} .$$

As a failsafe approach, the MCS may be rapidly decreased when a few consecutive packets are lost. The backoff MCS may typically be by a fixed offset or to a predefined MCS value. For example,

$$MCS ( t + 1 ) = \{ \begin{matrix}{argmax}_{MCS} PER ( MCS , t ) \leq {PER}_{Target} for regular conditions \\ MCS ( t ) - Δ when consecutive packets are lost\end{matrix} .$$

In some embodiments, Δ is, e.g., 5. Note that, in wireless link adaptation in frequency bands other than millimeter wave, the MCS is typically not dramatically increased when the channel fading improves.

However, block acknowledgment-based wireless link adaptation may face challenges during millimeter-wave communication. Notably, when motion occurs (such as rotation and/or blocking) in a millimeter-wave wireless link, beamforming may be invoked to reestablish the wireless link by applying a new beam-steering vector. When beamforming is invoked, the channel SNR typically changes (decreases or increases) significantly. Consequently, the MCS may need to increase quickly when beamforming improves the channel SNR, and may need to decrease or drop to a reasonable level when beamforming reestablishes the wireless link following a particular decrease in the SNR. Thus, the MCS may need to reset promptly and properly because millimeter-wave communication is usually very sensitive to motion (which may happen frequently).

Therefore, in some embodiments of the communication technique, signal-to-noise-based wireless link adaptation may be reset during a beamforming event or condition. Notably, when a beamforming event occurs (e.g., a beam-refinement procedure, beam tracking, or a sector sweep), a recipient-electronic-device may report the beamformed SNR. After receiving the SNR report in beamforming frames, the electronic device may reset the MCS. For example,

$$MCS ( t + 1 ) = \{ \begin{matrix}{argmax}_{MCS} PER ( MCS , t ) \leq {PER}_{Target} for regular conditions \\ f ( SNR , MCS ) when beamforming occurs\end{matrix} .$$

Thus, during and/or immediately following the beamforming condition, the SNR may be used to determine the MCS. In some embodiments, a predefined look-up table of SNRs and MCS values may be used. For example, a look-up table may be used to determine the MCS during and/or immediately following the beamforming condition. Alternatively or additionally, the MCS value as a function of the SNR may be learned, such as by using a moving average or filtered SNR to determine the MCS. This approach may provide aggressive MCS lowering during and/or immediately following the beamforming, and may provide accurate MCS values as the wireless link is restored.

FIG. 10 presents a drawing illustrating an example beamforming condition during communication using access point 112. Notably, at time 1010 (such as, e.g., 100 ms), blocking occurs and beamforming starts. In response, the channel SNR 1012 drops and the MCS 1014 may be reset, e.g., to the lowest MCS value. Then, at time 1016, the SNR may be reported. Because the SNR (or the RSSI) may be reported more rapidly and more accurately during the beamforming than the PER, access point 112 may use a look-up table of the SNR and the estimated MCS to determine the MCS. This may allow access point 112 to readapt to the channel conditions. This wireless link adaptation may restore the MCS to a proper level quickly (e.g., after the blocking and/or as a blocker moves away). Consequently, by time 1018 (such as, e.g., 200 ms), the beamforming has been completed and the channel SNR and, thus, the MCS are increased (e.g., the SNR may be greater than a threshold). Subsequently, the wireless link adaptation may once again be based at least in part on the PER. In contrast, using PER-based wireless channel link adaptation (WCLA) 1020 during beamforming may quickly back off the MCS to a predefined safe rate, but may increase the MCS more slowly (e.g., after the blocking and/or as a blocker moves away).

The wireless link adaptation during and immediately following beamforming is further illustrated in FIG. 11, which presents a flow diagram illustrating an example of communication between electronic device 110-1 and access point 112. Notably, during routine operation 1110, access point 112 may track the channel condition and may select the MCS accordingly. When there is motion 1112, the wireless link or channel may fade. This may be evidenced by the loss of consecutive acknowledgments. Consequently, beamforming may be invoked. Then, during beamforming 1114, the SNR may be reported in beamforming (BRP) frames or reports. Based on the reported SNR, the MCS may be reset. Subsequently, when the wireless link is restored (and, thus, during routine operation 1116), access point 112 may once again track the channel condition and may select the MCS accordingly.

In some embodiments of wireless link adaptation during or proximate to a beamforming condition, the wireless link adaptation is based at least in part on: an RSSI, an SNR and/or a signal-to-interference-plus-noise ratio (SINR). Note that the values in the beamforming report from electronic device 110-1 may be absolute values or a differential value with respect to a communication performance metric (such as an SNR) prior to the beamforming condition.

The beamforming report may use: the last RSSI field in a file header, physical or media access control (MAC) reserved field with the SNR or the RSSI, and/or a MAC element or field in a beamforming frame with the SNR or the RSSI.

In some embodiments of an SNR-based MCS reset, access point 112 may keep a record of different MCS as a function of SNR and/or PER in, e.g., a look-up table. Alternatively or additionally, access point 112 may maintain a look-up table with a difference or a change in the MCS as a function of the difference or the change in the SNR. Either or both of these look-up tables may be predetermined or predefined, or may be dynamically learned.

In summary, the communication technique may allow an electronic device to adjust the MCS values for different data streams independently based at least in part on PER tolerances (and, more generally, QoS criteria) of these data streams. Moreover, at least one of these data streams may be used to selectively probe the wireless link to assess the MCS value(s) that can be used. For example, a less important or lower priority data stream(s) with a higher MCS may be used to determine the MCS. During routine operation, PER may be used as a communication performance metric to determine the MCS adjustment and, thus, the wireless link adaptation. Moreover, during or proximate to a beamforming condition, the MCS may be reset, and then RSSI and/or SNR may be used to determine the subsequent MCS adjustment and, thus, the wireless link adaptation. The communication technique may allow low-latency and reliable millimeter-wave communication using a 60 GHz frequency band, such as in IEEE 802.11ad, IEEE 802.11ay, and/or another next generation 60 GHz communication protocol.

We now describe embodiments of an electronic device. FIG. 12 presents a block diagram of an electronic device 1200 (which may be a cellular telephone, an access point, another electronic device, etc.) in accordance with some embodiments. This electronic device includes processing subsystem 1210, memory subsystem 1212, and networking subsystem 1214. Processing subsystem 1210 includes one or more devices configured to perform computational operations. For example, processing subsystem 1210 can include one or more microprocessors, application-specific integrated circuits (ASICs), microcontrollers, graphics processing units (GPUs), programmable-logic devices, and/or one or more digital signal processors (DSPs).

Memory subsystem 1212 includes one or more devices for storing data and/or instructions for processing subsystem 1210 and networking subsystem 1214. For example, memory subsystem 1212 can include dynamic random access memory (DRAM), static random access memory (SRAM), a read-only memory (ROM), flash memory, and/or other types of memory. In some embodiments, instructions for processing subsystem 1210 in memory subsystem 1212 include: program instructions or sets of instructions (such as program instructions 1222 or operating system 1224), which may be executed by processing subsystem 1210. For example, a ROM can store programs, utilities or processes to be executed in a non-volatile manner, and DRAM can provide volatile data storage, and may store instructions related to the operation of electronic device 1200. Note that the one or more computer programs may constitute a computer-program mechanism, a computer-readable storage medium or software. Moreover, instructions in the various modules in memory subsystem 1212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1210. In some embodiments, the one or more computer programs are distributed over a network-coupled computer system so that the one or more computer programs are stored and executed in a distributed manner.

In addition, memory subsystem 1212 can include mechanisms for controlling access to the memory. In some embodiments, memory subsystem 1212 includes a memory hierarchy that comprises one or more caches coupled to a memory in electronic device 1200. In some of these embodiments, one or more of the caches is located in processing subsystem 1210.

In some embodiments, memory subsystem 1212 is coupled to one or more high-capacity mass-storage devices (not shown). For example, memory subsystem 1212 can be coupled to a magnetic or optical drive, a solid-state drive, or another type of mass-storage device. In these embodiments, memory subsystem 1212 can be used by electronic device 1200 as fast-access storage for often-used data, while the mass-storage device is used to store less frequently used data.

Networking subsystem 1214 includes one or more devices configured to couple to and communicate on a wired and/or wireless network (i.e., to perform network operations), including: control logic 1216, an interface circuit 1218 and a set of antennas 1220 (or antenna elements) in an adaptive array that can be selectively turned on and/or off by control logic 1216 to create a variety of optional antenna patterns or ‘beam patterns.’ (While FIG. 12 includes set of antennas 1220, in some embodiments electronic device 1200 includes one or more nodes, such as nodes 1208, e.g., a pad, which can be coupled to set of antennas 1220. Thus, electronic device 1200 may or may not include set of antennas 1220.) For example, networking subsystem 1214 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some embodiments, networking subsystem 1214 includes one or more radios, such as a wake-up radio that is used to receive wake-up frames, and a main radio that is used to transmit and/or receive frames or packets during a higher-power mode. The wake-up radio and the main radio may be implemented separately (such as using discrete components or separate integrated circuits) or in a common integrated circuit.

Networking subsystem 1214 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1200 may use the mechanisms in networking subsystem 1214 for performing simple wireless communication between the electronic devices, e.g., transmitting advertising or frame frames and/or scanning for advertising frames transmitted by other electronic devices.

Within electronic device 1200, processing subsystem 1210, memory subsystem 1212, and networking subsystem 1214 are coupled together using bus 1228 that facilitates data transfer between these components. Bus 1228 may include an electrical, optical, and/or electro-optical connection that the subsystems can use to communicate commands and data among one another. Although only one bus 1228 is shown for clarity, different embodiments can include a different number or configuration of electrical, optical, and/or electro-optical connections among the subsystems.

In some embodiments, electronic device 1200 includes a display subsystem 1226 for displaying information on a display, which may include a display driver and the display, such as a liquid-crystal display, a multi-touch touchscreen, etc. Display subsystem 1226 may be controlled by processing subsystem 1210 to display information to a user (e.g., information relating to incoming, outgoing, or an active communication session).

Electronic device 1200 can also include a user-input subsystem 1230 that allows a user of the electronic device 1200 to interact with electronic device 1200. For example, user-input subsystem 1230 can take a variety of forms, such as: a button, keypad, dial, touch screen, audio input interface, visual/image capture input interface, input in the form of sensor data, etc.

Electronic device 1200 can be (or can be included in) any electronic device with at least one network interface. For example, electronic device 1200 may include: a cellular telephone or a smartphone, a tablet computer, a laptop computer, a notebook computer, a personal or desktop computer, a netbook computer, a media player device, an electronic book device, a MiFi® device, a smartwatch, a wearable computing device, an auxiliary or virtual reality headset or display, a portable computing device, a consumer-electronic device, an access point, a router, a switch, communication equipment, test equipment, as well as any other type of electronic computing device having wireless communication capability that can include communication via one or more wireless communication protocols.

Although specific components are used to describe electronic device 1200, in alternative embodiments, different components and/or subsystems may be present in electronic device 1200. For example, electronic device 1200 may include one or more additional processing subsystems, memory subsystems, networking subsystems, and/or display subsystems. Additionally, one or more of the subsystems may not be present in electronic device 1200. Moreover, in some embodiments, electronic device 1200 may include one or more additional subsystems that are not shown in FIG. 12. Also, although separate subsystems are shown in FIG. 12, in some embodiments some or all of a given subsystem or component can be integrated into one or more of the other subsystems or component(s) in electronic device 1200. For example, in some embodiments program instructions 1222 are included in operating system 1224 and/or control logic 1216 is included in interface circuit 1218.

Moreover, the circuits and components in electronic device 1200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1214. This integrated circuit may include hardware and/or software mechanisms that are used for transmitting wireless signals from electronic device 1200 and receiving signals at electronic device 1200 from other electronic devices. Aside from the mechanisms herein described, radios are generally known in the art and hence are not described in detail. In general, networking subsystem 1214 and/or the integrated circuit can include any number of radios. Note that the radios in multiple-radio embodiments function in a similar way to the described single-radio embodiments.

In some embodiments, networking subsystem 1214 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques may be used. Thus, the communication technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication technique may be implemented using program instructions 1222, operating system 1224 (such as a driver for interface circuit 1218) or in firmware in interface circuit 1218. Alternatively or additionally, at least some of the operations in the communication technique may be implemented in a physical layer, such as hardware in interface circuit 1218. In some embodiments, the communication technique is implemented, at least in part, in a MAC layer and/or in a physical layer in interface circuit 1218.

While examples of numerical values are provided in the preceding discussion, in other embodiments different numerical values are used. Consequently, the numerical values provided are not intended to be limiting.

While the preceding embodiments illustrated communication between an electronic device and a recipient electronic device, in other embodiments the communication technique may be used during communication between an electronic device (which may be other than or different from an access point) and the recipient electronic device. Moreover, while the preceding embodiments illustrated communication in a 60 GHz frequency band, in other embodiments the communication technique may be used during communication in another or a different frequency band, such as: 900 MHz, 2.4 GHz, 5 GHz, 60 GHz, and/or a band of frequencies used by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a node configured to communicatively couple to an antenna; and
an interface circuit, communicatively coupled to the node, configured to communicate with a recipient electronic device, and configured to:
transmit, via the node, at least two data streams, wherein a first data stream of the at least two data streams has a higher quality-of-service (QoS) criterion and a lower modulation coding scheme (MCS), and a second data stream of the at least two data streams has a lower QoS criterion and a higher MCS;
estimate a communication performance metric associated with the second data stream; and
selectively transmit, via the node, an MCS probe associated with the second data stream based at least in part on the communication performance metric and the lower QoS criterion.

2. The electronic device of claim 1, wherein the interface circuit is configured to:
receive, at the node, feedback information associated with the recipient electronic device and the MCS probe; and
modify at least one of the first MCS or the second MCS based at least in part on the feedback information.

3. The electronic device of claim 1, wherein a given QoS criterion comprises a packet-error-rate (PER) threshold.

4. The electronic device of claim 1, wherein the communication performance metric comprises at least one of a PER, a received signal strength, or a signal-to-noise ratio (SNR).

5. The electronic device of claim 1, wherein the MCS probe uses a probe MCS that is different from the second MCS.

6. The electronic device of claim 1, wherein the first data stream and the second data stream are associated with a 60 GHz frequency band.

7. The electronic device of claim 1, wherein, during a beamforming condition, the interface circuit is configured to reset at least one of the first MCS or the second MCS to a predetermined MCS.

8. A non-transitory computer-readable storage medium for use in conjunction with an electronic device, the computer-readable storage medium storing program instructions that, when executed by the electronic device, cause the electronic device to selectively transmit a probe by carrying out one or more operations comprising:
transmitting at least two data streams, wherein a first data stream of the at least two data streams has a higher quality-of-service (QoS) criterion and a lower modulation coding scheme (MCS), and a second data stream of the at least two data streams has a lower QoS criterion and a higher MCS;
estimating a communication performance metric associated with the second data stream; and
selectively transmitting an MCS probe associated with the second data stream based at least in part on the communication performance metric and the lower QoS criterion.

9. The computer-readable storage medium of claim 8, wherein the one or more operations comprise:
receiving feedback information associated with a recipient electronic device and the MCS probe; and
modifying at least one of the first MCS or the second MCS based at least in part on the feedback information.

10. The computer-readable storage medium of claim 8, wherein a given QoS criterion comprises a packet-error-rate (PER) threshold.

11. The computer-readable storage medium of claim 8, wherein the communication performance metric comprises at least one of a PER, a received signal strength, or a signal-to-noise ratio (SNR).

12. The computer-readable storage medium of claim 8, wherein the MCS probe uses a probe MCS that is different from the second MCS.

13. The computer-readable storage medium of claim 8, wherein the first data stream and the second data stream are associated with a 60 GHz frequency band.

14. The computer-readable storage medium of claim 8, wherein the one or more operations further comprise resetting, during a beamforming condition, at least one of the first MCS or the second MCS to a predetermined MCS.

15. A method for selectively transmitting a probe, comprising:
by an electronic device:
transmitting at least two data streams, wherein a first data stream of the at least two data streams has a higher quality-of-service (QoS) criterion and a lower modulation coding scheme (MCS), and a second data stream of the at least two data streams has a lower QoS criterion and a higher MCS;
estimating a communication performance metric associated with the second data stream; and
selectively transmitting an MCS probe associated with the second data stream based at least in part on the communication performance metric and the lower QoS criterion.

16. The method of claim 15, wherein the method comprises:
receiving feedback information associated with a recipient electronic device and the MCS probe; and
modifying at least one of the first MCS or the second MCS based at least in part on the feedback information.

17. The method of claim 15, wherein a given QoS criterion comprises a packet-error-rate (PER) threshold; and
wherein the communication performance metric comprises at least one of a PER, a received signal strength, or a signal-to-noise ratio (SNR).

18. The method of claim 15, wherein the MCS probe uses a probe MCS that is different from the second MCS.

19. The method of claim 15, wherein the first data stream and the second data stream are associated with a 60 GHz frequency band.

20. The method of claim 15, wherein the method comprises resetting, during a beamforming condition, at least one of the first MCS or the second MCS to a predetermined MCS.
